(19) United States
(12) Patent Application Publication
(10) Pub. No.: US 2026/0233373 A1
(43) Pub. Date: Aug. 13, 2026

(54) TWO-PART PISTON HYDRAULIC TOOL

(71) Applicant: Milwaukee Electric Tool Corporation, Brookfield, WI (US)

(72) Inventors: Jean Mauricio Uruena Montoya, Wauwatosa, WI (US); Benjamin J. Tretow, Mequon, WI (US); Mathew R. Rentmeester, Wauwatosa, WI (US); Daniel Garces, Waukesha, WI (US); Robert L. Markus, Mukwonago, WI (US)

(21) Appl. No.: 19/532,828

(22) Filed: Feb. 6, 2026

Related U.S. Application Data
(60) Provisional application No. 63/756,699, filed on Feb. 10, 2025.

(51) Int. Cl. B25F 5/00; F15B 15/14

(52) U.S. Cl. CPC B25F 5/005; F15B 15/1457

(57) ABSTRACT

A hydraulic actuator for a hydraulic tool includes a cylinder having a first peripheral wall extending between a first wall that includes an opening and a second wall. A ram is moveably disposed within the cylinder and includes a rod extending through the opening in the first wall from a first end to a second end. A piston head is at the first end of the rod and is disposed within the interior space to define a first chamber between the first wall and the piston head and to define a second chamber between the piston head and the second wall. A flange is at the second end of the rod and is positioned outside of the interior space. The flange engages the first wall to limit movement of the ram in a first direction caused by fluid being supplied to the first chamber.

### CROSS-REFERENCE TO RELATED APPLICATIONS

This application claims priority to U.S. Provisional Patent Application No. 63/756,699, filed on Feb. 10, 2025, which is incorporated herein by reference in its entirety.

### BACKGROUND

The present disclosure relates to hydraulic tools. Hydraulic tools include a cylinder that has an end cap coupled to the cylinder. The end cap creates a seal in the cylinder to prevent fluid leakage. End caps also support the force of a ram. For example, the end cap can include threads to couple with a cylinder wall and disperse the load applied to the ram.

### SUMMARY

According to one aspect of the present disclosure, a hydraulic actuator for a hydraulic tool can include a cylinder having a first peripheral wall extending between a first wall and a second wall to define an interior space. The first wall can include an opening. A ram can be moveably disposed within the cylinder. The ram can include a rod that extends through the opening in the first wall from a first end to a second end. The ram can include a piston head at the first end of the rod and disposed within the interior space to define a first chamber between the first wall and the piston head and to define a second chamber between the piston head and the second wall. The ram can include a flange at the second end of the rod and positioned outside of the interior space. The flange can engage the first wall to limit movement of the ram in a first direction caused by fluid being supplied to the first chamber.

In some examples, the flange may be formed as a unitary component with the rod and the piston head may be a separate component that is coupled to the rod.

In some examples, the flange may include an axial protrusion that is received in a channel formed in the first wall.

In some examples, the axial protrusion may be a circumferential wall.

In some examples, a bumper may be coupled to the axial protrusion to be between the axial protrusion and the first wall.

In some examples, the cylinder may include a second peripheral wall extending from the first wall and away from the second wall so that the first wall is an interior wall of the cylinder.

In some examples, the second wall may be a cap that is coupled to the first peripheral wall.

In some examples, the cap may be coupled to the first peripheral wall by a retainer.

In some examples, a seal may be formed between the cap and the first peripheral wall so that the second chamber is a flooded chamber.

In some examples, an O-ring or a gasket may be positioned between the cap and the first peripheral wall to form the seal.

In some examples, an inlet may be provided at the first chamber and an outlet may be provided at the second chamber so that fluid is pumped from the second chamber to the first chamber to cause the ram to move in the first direction.

According to another aspect of the present disclosure, a hydraulic actuator for a hydraulic tool can include a cylinder that includes a peripheral wall and a first wall integrally formed with the peripheral wall. The first wall can define an opening. A piston can be moveably received within the cylinder. The piston can include a first piston piece that extends through the opening from a first end and a second end and a second piston piece that is coupled to the first piston piece at the second end. The first wall and the second piston piece can define a first chamber. The first end of the first piston piece can contact the first wall to limit movement of the piston in a first direction caused by fluid being supplied to the first chamber.

In some examples, the cylinder may include a removable second wall, and the peripheral wall may extend between the first wall and the second wall.

In some examples, the second piston piece and the second wall may define a second chamber.

In some examples, the second piston piece may contact the first wall to limit movement of the piston in a second direction caused by fluid being supplied to the second chamber.

In some examples, the second piston piece may contact an interior protrusion of the first wall.

In some examples, the first end of the first piston piece may include a flange that is located outside the first chamber and engages the first wall to limit movement of the piston in the first direction.

In some examples, the flange may include an axial protrusion that is received in a channel formed in the first wall.

According to yet another aspect of the present disclosure, a hydraulic tool can include a housing. A working head can be coupled to the housing. A hydraulic actuator can include a cylinder having a first peripheral wall extending between a first wall and a second wall to define an internal volume. The first wall can include an opening. The second wall can be defined by a cap coupled to the first peripheral wall. A ram can be moveably disposed within the cylinder. The ram can include a rod extending through the opening in the first wall from a first end positioned outside of the internal volume to a second end positioned inside the internal volume. The ram can include a piston head coupled to the second end of the rod and disposed within the internal volume to define a first chamber between the first wall and the piston head and to define a second chamber between the piston head and the cap. The ram can include a flange at the first end of the rod and positioned outside of the internal volume. The flange can engage the first wall to limit movement of the ram in a first direction caused by fluid being supplied to the first chamber. A pump can be positioned in the housing to supply the fluid to the first chamber.

According to yet another aspect of the present disclosure, a method of assembling a hydraulic actuator can include providing a cylinder having a peripheral wall extending between a first wall and a second end of the peripheral wall to define an internal volume. The first wall can include an opening. The method can include inserting a piston rod through the opening in the first wall. The piston rod can have a first end and a second end. The first end can include a flange positioned outside of the internal volume. The method can include inserting a piston head into the internal volume through an opening at the second end of the peripheral wall. The method can include coupling the piston head to the second end of the piston rod. The method can include inserting a cap into the opening at the second end of the peripheral wall. The method can include coupling the cap to the peripheral wall to enclose and seal the internal volume.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is an axonometric view of a hydraulic tool according to the present disclosure.

FIG. 2 is a schematic view of the hydraulic tool of FIG. 1.

FIG. 3 is a side view of FIG. 1.

FIG. 4 is a cross-sectional view of FIG. 3 taken along the line IV-IV to show a ram received in a cylinder of a hydraulic actuator.

FIG. 5 is a detail view of the hydraulic actuator of FIG. 4, taken about line V-V.

FIG. 6 is a detail view of the hydraulic actuator of FIG. 4, taken about line VI-VI.

FIG. 7 is a flowchart of a method of assembling the hydraulic actuator of FIG. 4.

### DETAILED DESCRIPTION

Hydraulic tools generally include a hydraulic actuator that generates an output force to perform a work function on a workpiece (e.g., a cut, a crimp, or a punch). Conventional hydraulic tools generally utilize hydraulic pressure to move a ram within a cylinder between a first position and a second position. In some examples, the hydraulic tool is a single-acting cylinder that creates force in a first direction. In other examples, the hydraulic tool is a double-acting cylinder that creates force in a first direction and a second direction. In some cases, the first direction corresponds with extension of the piston, and the second direction corresponds with retraction of the piston, or vice versa.

In some cases, a cylinder can include a physical stop for a ram to limit movement of the ram. For example, conventional designs sometimes include a cap coupled to a cylinder, which provides an end wall. To support the force of the ram, the cap includes threads to couple with a cylinder wall and disperse the load applied by the ram. However, such arrangements can be difficult to seal due to loading on the cap when the ram makes contact, and can add bulk and weight to the tool.

Accordingly, the present disclosure provides improved arrangements of a hydraulic actuator that allows a hydraulic tool to reduce in size and weight, as well as providing improved cylinder sealing that can allow for fluid to be stored within the cylinder. This in turn can allow for reduced-volume bladders to be used. In particular, a cylinder can include a front wall (e.g., a first wall) and a cap that defines a back wall (e.g., a second wall). The ram can include a rod that extends through the front wall and the front wall can be configured as a stop that limits both extension and retraction of the ram. For example, a head of the ram can engage the front wall during extension and a flange of a rod of the ram can engage the front wall during retraction. There is space between the piston head and the cap when the ram is fully retracted. This removes the loading from the cap and allows for the cap to be a reduced size, as compared to conventional cylinder designs.

This can also allow for alternative fastening systems to be used to attach the cap to the cylinder to improve sealing therebetween. For example, the cap utilizes a retaining clip (e.g., a circlip) to retain the cap in the cylinder and seals (e.g., O-rings, gaskets, etc.) to be positioned between the cap and the cylinder for sealing. Correspondingly, a second chamber can be a flooded chamber that can serve as a reservoir and allow a bladder to be reduced in size or removed, which can further reduce tool size.

In some cases, a ram can be formed as a multi-piece ram to allow for easier assembly. For example, the ram is received in a cylinder and includes a rod and a piston head. The rod and the piston head are coupled together by a retainer.

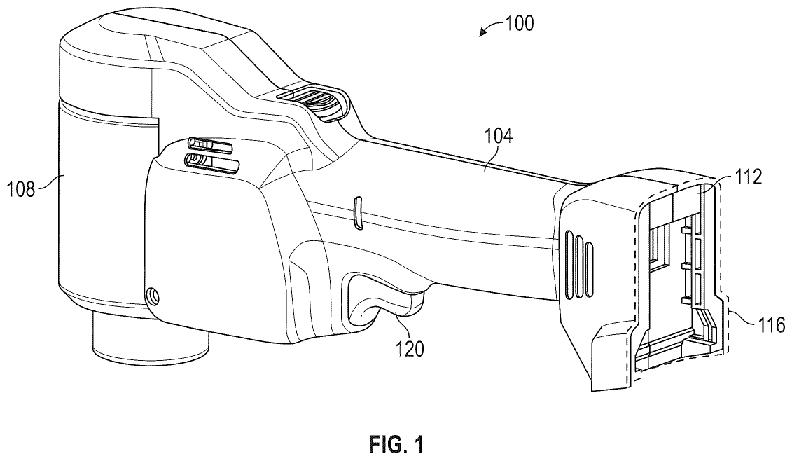

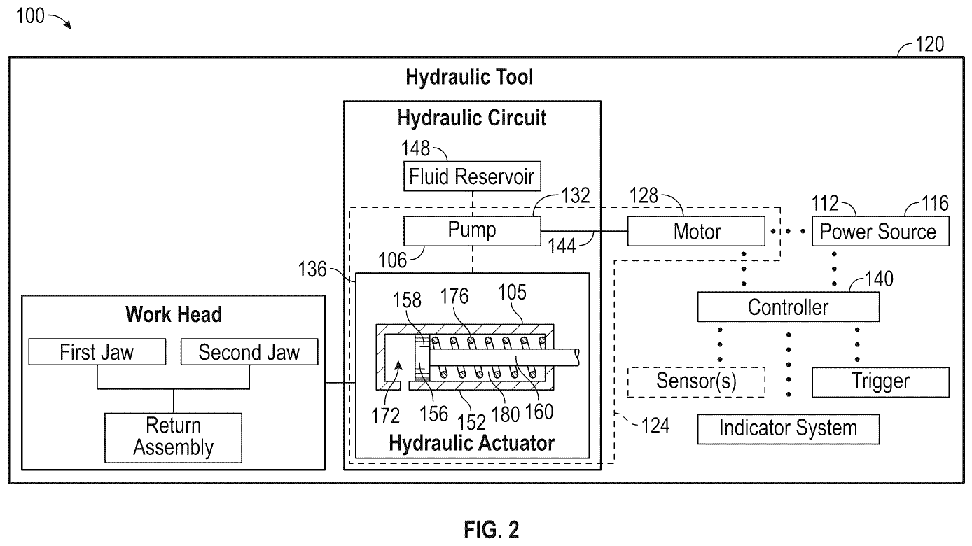

FIGS. 1 and 2 illustrate an example of a hydraulic tool 100, in accordance with the present disclosure. Although the example implementation described herein references a knockout tool, the features of this disclosure can be implemented in other similar tools, such as cutting tools, crimping tools, etc. In addition, any suitable size, shape or type of elements or materials could be used. The illustrated hydraulic tool 100 includes a housing 104 and a working head 108 that is coupled to the housing 104 to perform an operation on a work piece. The working head 108 is illustrated as a knockout punch; however other types of working heads can also be used. The housing 104 defines a cylinder housing 105 that is attached to the working head 108 and a pump housing 106. The cylinder housing 105 includes a cylinder 152 and the pump housing 106 includes a pump 132. In some examples, the hydraulic tool 100 can be battery-operated and the housing 104 can define a battery receptacle 112 that is configured to receive a battery 116. In other examples the hydraulic tool 100 can be corded.

To operate the hydraulic tool 100, a trigger 120 is coupled to the housing 104. The trigger 120 can be manipulated by a user to actuate the hydraulic tool 100 and perform the work operation. For example, actuating the trigger 120 can control operation of an output assembly 124 that is disposed within the housing 104. The output assembly 124 includes a motor 128, the pump 132, and a hydraulic actuator 136 that acts on the working head 108 to perform the work operation. The pump 132 is positioned in the housing 104. When the trigger 120 is pressed, electrical current can flow from the battery 116 to the output assembly 124, causing the output assembly 124 to operate the working head 108 to perform the work operation. In some cases, the trigger 120 can communicate with an electronic controller 140 that controls a flow of electrical current from the battery 116 or another power source. More specifically, the electrical current can be provided to the motor 128 of the output assembly 124. The motor 128 can be coupled to the pump 132 so that rotation of the motor 128 operates the pump 132 to supply pressurized hydraulic fluid to the hydraulic actuator 136. In some cases, the motor 128 can be coupled to the pump 132 via a transmission 144 (e.g., a gear reducer). The pump 132 supplies hydraulic fluid from a reservoir 148 (e.g., a tank) to the hydraulic actuator 136.

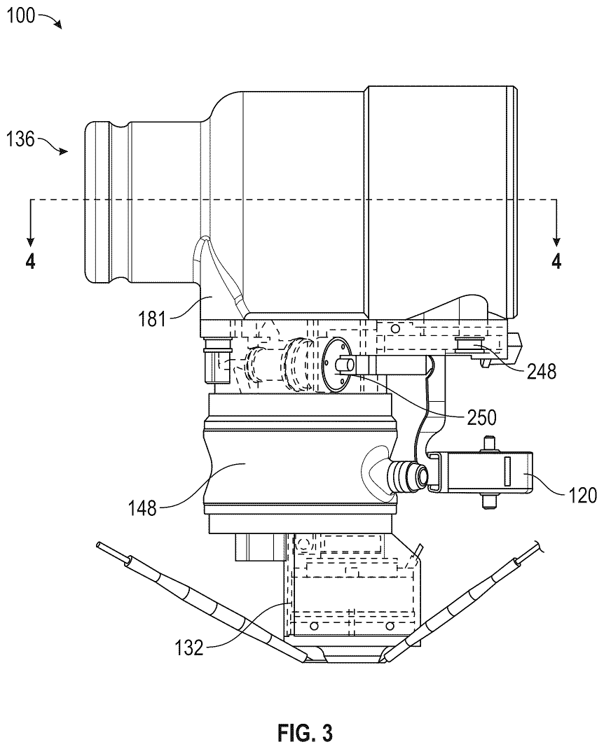

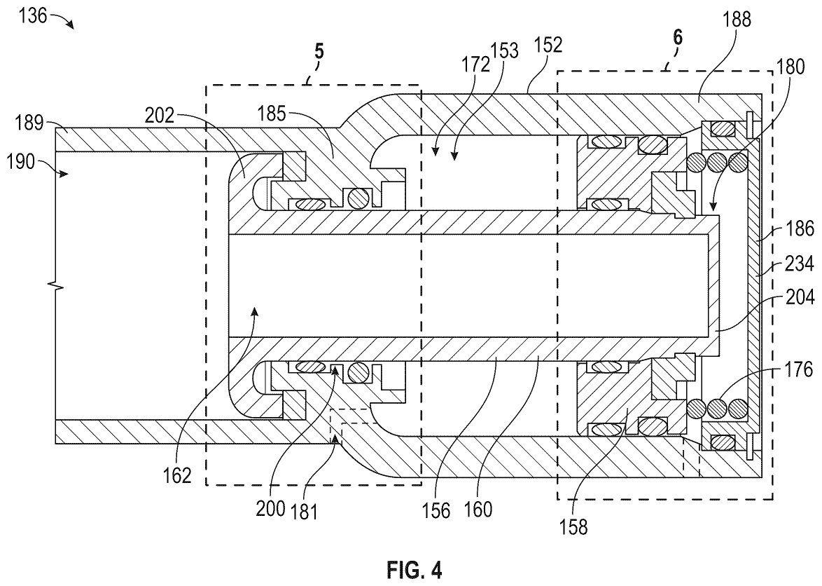

With additional reference to FIGS. 3 and 4, in general, the hydraulic actuator 136 includes a piston 156 (e.g., a ram) having a piston head 158 (e.g., second piston piece) and a piston rod 160 (e.g., first piston piece). The piston 156 is moveably received in an internal volume 153 of a cylinder 152 to form a first chamber 172 and a second chamber 180 within the internal volume 153 of the cylinder 152. As discussed in greater detail below, one or more seals are provided to seal between the piston head 158 and the cylinder 152 to prevent fluid from leaking between the first chamber 172 and the second chamber 180. The piston 156 includes a bore 162 in the piston rod 160.

To operate the hydraulic actuator 136, the cylinder 152 uses pressurized fluid to create mechanical motion. For example, hydraulic fluid is pumped into the first chamber 172. The pressure acting on the surface area of the piston 156 generates a force that causes the piston 156 to move within the cylinder 152 between a first position (e.g., a retracted position or an extended position) and a second position (e.g., the other of the retracted position and the extended position). In some cases, the cylinder 152 is single acting. For example, hydraulic fluid is pumped to apply pressure to one side (e.g., the first chamber 172) of the piston 156.

In other cases, the cylinder 152 can be configured differently to be a double-acting cylinder. In the case of a double acting cylinder, hydraulic fluid is pumped to selectively apply pressure to either side (e.g., the first chamber 172 and the second chamber 180) of the piston 156 to move the piston 156 in a desired direction. Hydraulic fluid creates pressure along the surface of the piston head 158 that defines the first chamber 172, generating a force to move the piston 156 between the first position and the second position. To move the piston 156 between the second position and the first position, hydraulic fluid creates pressure along the surface of the piston head 158 that defines the second chamber 180 to generate a force.

A hydraulic tool arrangement can include a hydraulic actuator that includes passages to allow a pump to pump fluid from a bladder into the hydraulic actuator to move a ram in a first direction (e.g., retraction of the working head 108). Referring to FIGS. 3 and 4, the hydraulic actuator 136 includes a first passage 181 (e.g., inlet) to allow fluid to be pumped into the first chamber 172. More specifically, the pump 132 pumps fluid from the reservoir 148 through the first passage 181 to move the piston 156 in a first direction. To move the piston 156 in the second direction, fluid can be drained from the first chamber 172 to the second chamber 180 either via the first passage 181 or another passage.

An improved arrangement of a hydraulic actuator allows a hydraulic tool to reduce in size and weight. As shown in FIG. 4, the hydraulic actuator 136 includes the cylinder 152 and the piston 156. The cylinder 152 includes a first peripheral wall 188 that extends between a first wall 185 and a second wall 186 to define the internal volume 153 of the cylinder 152. In some cases, the cylinder 152 includes a second peripheral wall 189 to define an opening 190 to receive the working head 108. The second peripheral wall 189 extends from the first wall 185 and away from the second wall 186 so that the first wall 185 is an interior wall of the cylinder 152. In some examples, the first wall 185 can be arranged differently. For example, the first wall 185 can be an exterior wall of the cylinder 152.

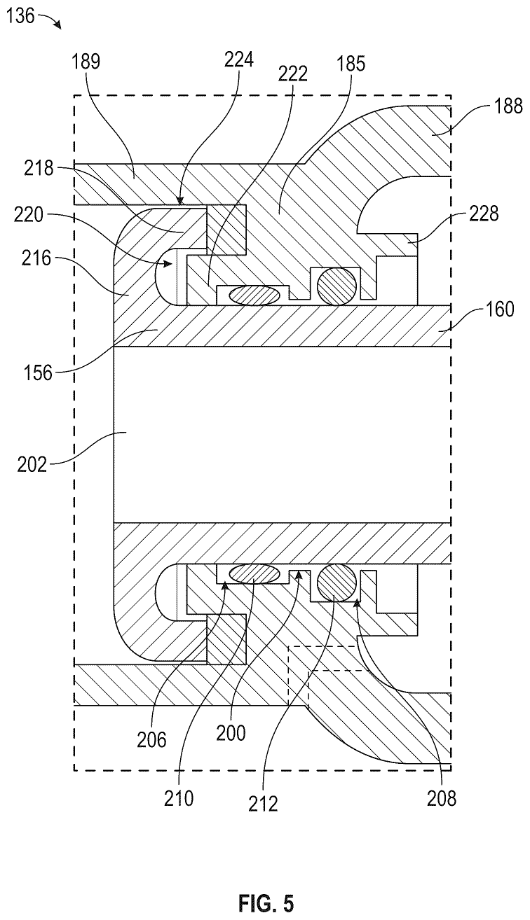

In some examples, a first end wall and a peripheral wall of a cylinder can be integrally formed with one another and a second end wall can be defined by a cap that is coupled to the peripheral wall. This arrangement allows a ram (e.g., a piston head or piston rod) to be placed into the cylinder for assembly. Correspondingly, the first wall can act as a limit stop to control motion of the ram in both a first direction and a second direction. For example, as shown in FIGS. 4 and 5, the first wall 185 is formed as a unitary structure with the first peripheral wall 188. The first wall 185 includes an opening 200 to allow the piston 156 (e.g., the piston rod 160) to extend through the first wall 185. Specifically, a first end 202 of the piston 156 is positioned outside of the internal volume 153 of the cylinder 152 and a second end 204 of the piston 156 is positioned inside the internal volume 153 of the cylinder 152.

To prevent fluid from leaking through the opening 200 and out of the first chamber 172, a seal can be positioned between the piston rod 160 and the first wall 185. For example, referring to FIG. 5, the first wall 185 defines a first groove 206 to receive a first seal 210 and a second groove 208 to receive a second seal 212 (e.g., a wear band) to seal against the piston 156 (e.g., the piston rod 160). In other examples, seals can be arranged differently.

A flange 216 is provided at the first end 202 of the piston 156 (e.g., the piston rod 160) to engage the first wall 185 at a fully retracted position of the piston 156. In the illustrated example, the flange 216 includes an axial protrusion 218 that extends toward the second end 204 of the piston 156 (e.g., toward the piston head 158). The axial protrusion 218 can be formed as a cylindrical wall (e.g., a circumferential wall). In some cases, the flange 216 and the piston rod 160 can define a groove 220 therebetween, which can receive a corresponding exterior protrusion 222 (e.g., a boss or wall) of the first wall 185, as may help to align the piston 156. In some cases, the first wall 185 can define a groove 224 (e.g., a channel, with the second peripheral wall 189) that receives the axial protrusion 218 of the flange 216, as may help to align the piston 156. In some cases, a bumper can be coupled to the flange 216 or the first wall 185 to absorb contact forces at the fully retracted position. For example, a bumper can be positioned between the axial protrusion 218 and the first wall 185. In the fully retracted position, the contact between the first wall 185 and the flange 216 prevents the piston head 158 from making direct contact with the second wall 186 (e.g., a cap). This can remove substantially all the force of the piston 156 from the cap 234, except as applied by a return mechanism 176 if optionally positioned in the second chamber 180 between the piston 156 and the cap 234.

The piston head 158 is provided at the second end 204 of the piston 156 (e.g., the piston rod 160) to engage the first wall 185 at a fully extended position of the piston 156. In some cases, the first wall 185 includes an interior protrusion 228 (e.g., a boss or wall) that engages with the piston head 158. The interior protrusion 228 can space the piston head 158 from the remaining area of the first wall 185 in the fully extended position. This maintains a minimum volume (e.g., head space) of the first chamber 172. The minimum volume can prevent hydraulic lock and allow for controlled fluid displacement during operation of the hydraulic actuator 136. In some examples, the interior protrusion 228 is formed as an annular boss that extends from the first wall 185 toward the second wall 186. The interior protrusion 228 can be integrally formed with the first wall 185. Alternatively, the interior protrusion 228 can be a separate component that is coupled to the first wall 185.

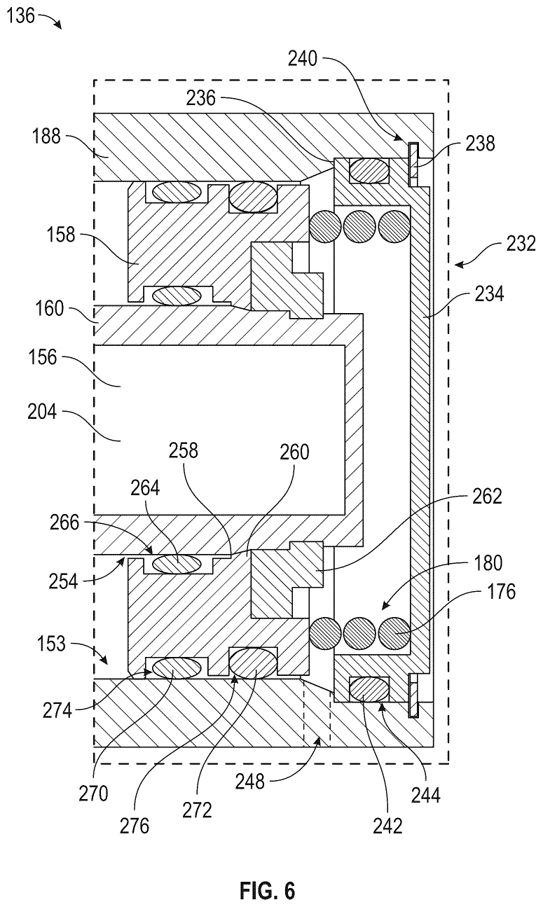

By using a first wall as a limit stop to limit ram motion in both a first direction and a second direction, the hydraulic forces acting on the ram can be substantially removed from a cap that forms the second wall of the cylinder. This allows for alternative fastening arrangements and reduced cap size and weight. Referring now to FIG. 6, the end of the first peripheral wall 188 includes an opening 232 that receives a cap 234 that defines the second wall 186. The cap 234 is removable from the first peripheral wall 188. A seat 236 is defined at the opening 232 to receive the cap 234. The cap 234 is retained against the seat 236 by a retainer 238. In this case, the retainer 238 is configured as a circlip that is positioned in a groove 240 defined in the first peripheral wall 188. In other examples, the retainer 238 can be configured differently, for example, as a threaded collar, a snap ring, etc.

In some examples, improved sealing arrangements between a cap and a peripheral wall of a cylinder can allow a second chamber to be configured as a flooded chamber that stores hydraulic fluid. This can allow for smaller reservoirs to be used to further reduce tool size. In the illustrated example, a seal 242 is positioned between the cap 234 and the first peripheral wall 188. In the illustrated example, the seal 242 is an O-ring that is positioned in a groove 244 defined in the cap 234. In other examples, seals can be configured differently, for example, as an O-ring in a groove in the first peripheral wall 188, a gasket between the seat 236 and the cap 234, etc. The seal 242 can prevent fluid from leaking out of the second chamber 180 and can thereby allow the second chamber 180 to be a flooded chamber. This allows the second chamber 180 to be used as a reservoir to reduce the size of or eliminate the need for the external reservoir 148. In some cases, this can also allow the hydraulic actuator to be configured as a double-acting cylinder.

Correspondingly, a second passage 248 (e.g., outlet) can be defined in the cylinder 152 (e.g., in the first peripheral wall 188). In some cases, the first passage 181 can serve as an inlet to the first chamber 172 and the second passage 248 can serve as an outlet from the second chamber 180. In operation, fluid can be pumped from the second chamber 180 or the reservoir 148 to move the piston 156 in the first direction. When the piston 156 is moved in the second direction, fluid can be drained back to the second chamber 180 or the reservoir 148, either via the pump 132 or via a valve 250 (see FIG. 3) that connects the first chamber 172 to the second chamber 180. In some examples, the valve 250 can automatically open when the trigger 120 is released (e.g., via mechanical linkage between the trigger 120 and the valve 250 or via a signal from the electronic controller 140).

In some examples, a ram can be formed as a multi-piece ram to allow for easier assembly. In the illustrated example, the piston 156 is a two-piece ram. In the two-piece ram, the piston rod 160 and the piston head 158 are discrete components that are coupled together. As mentioned above, the first end 202 of the piston rod 160 includes the flange 216 and the piston head 158 is coupled to the second end 204 of the piston rod 160. Here, the flange 216 is formed as a unitary component with the piston rod 160. The unitary formation of the flange 216 with the piston rod 160 can provide increased structural integrity. The unitary formation can also reduce the number of sealing interfaces required.

However, in other examples, the flange 216 can be a separate component that is coupled to the piston rod 160. In such examples, the piston head 158 can be formed as a unitary component with the piston rod 160. This alternative configuration can be advantageous when different materials are desired for the flange 216 and the piston rod 160. For example, the flange 216 can be formed from a material having high wear resistance. The piston rod 160 can be formed from a material having high tensile strength.

Correspondingly, the ram can be a three-piece ram. In the three-piece ram, both the flange 216 and the piston head 158 are formed as discrete components from the piston rod 160. The three-piece ram configuration can provide maximum flexibility in material selection. The three-piece ram configuration can also allow for individual replacement of worn components. In the three-piece ram configuration, the flange 216 can be coupled to the piston rod 160 by threading, press fitting, or other suitable fastening methods. Similarly, the piston head 158 can be coupled to the piston rod 160 by the retainer 262 as described above.

To install the piston 156, the piston rod 160 can be inserted through the opening 200 in the first wall 185 to position the second end 204 of the piston rod 160 in the internal volume 153 of the cylinder 152. The piston head 158 can be inserted into the internal volume 153 through the opening 232 at a second end of the first peripheral wall 188 to be coupled to the piston rod 160. The cap 234 can be inserted into the opening 232 and coupled to the first peripheral wall 188 by the retainer 238 to enclose and seal the internal volume 153.

A piston head can be coupled to a piston rod so that they move together during extension and retraction. In the illustrated example, the piston head 158 defines an opening 254 that receives the second end 204 of the piston rod 160. Correspondingly, the piston rod 160 defines a seat 258 that engages a corresponding seat 260 positioned in the opening 254 of the piston head 158. The piston head 158 (e.g., the seat 260) is retained against the seat 258 of the piston rod 160 by a retainer 262. In this case, the retainer 262 is configured as a collar that is threaded onto the piston rod 160. In other examples, the retainer 262 can be configured differently, for example, as a press fit collar, a circlip, a snap ring, etc.

As mentioned above, a piston head divides an interior volume of a cylinder into a first chamber and a second chamber. To prevent fluid from leaking past the piston head between the first chamber and the second chamber, the piston head can include a seal. Still referring to FIG. 6, a first seal 264 is positioned between the piston head 158 and the piston rod 160. The first seal 264 is disposed in a first groove 266 defined in the piston head 158 (e.g., within the opening 254) to prevent leaks therebetween. In other examples, the first seal 264 can be configured differently, for example, to be positioned in a groove defined in the piston rod 160. Additionally, a second seal 270 and a third seal 272 are positioned between the piston head 158 and the first peripheral wall 188. The second seal 270 is disposed in a second groove 274 defined in the piston head 158 and the third seal 272 is disposed in a third groove 276 defined in the piston head 158. In this way, the second seal 270 and the third seal 272 move with the piston head 158 as the piston 156 is extended and retracted.

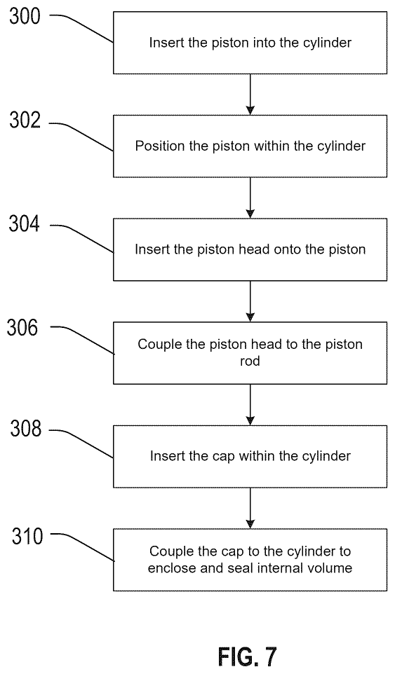

Referring now to FIG. 7, a method of assembling the hydraulic actuator 136 is illustrated. The method includes a block 300 of inserting the piston 156 is inserted into the cylinder 152. In particular, the piston 156 is inserted through the opening 200 in the first wall 185 of the cylinder 152. That is, the piston rod 160 is inserted through the opening 200 in the first wall 185 of the cylinder 152. The piston rod 160 is oriented so that the first end 202 is positioned outside of the internal volume 153. More specifically, the piston rod 160 is orientated so that the flange 216 is positioned outside of the internal volume 153. The first seal 210 and the second seal 212 are positioned in the first groove 206 and the second groove 208, respectively, to seal against the piston rod 160.

At block 302, the piston 156 is positioned within the cylinder 152. More specifically, the piston rod 160 is positioned within the cylinder 152. The piston rod 160 is advanced through the opening 200 in the first wall 185 until the second end 204 extends sufficiently into the internal volume 153 to allow coupling with the piston head 158. During insertion, the piston rod 160 passes through the first seal 210 and the second seal 212, which are positioned in the first groove 206 and the second groove 208, respectively. The seals engage the outer surface of the piston rod 160 to establish a fluid-tight interface at the opening 200. The flange 216 at the first end 202 of the piston rod 160 remains outside of the internal volume 153 and serves as a stop that prevents the piston rod 160 from being fully inserted into the cylinder 152. The axial protrusion 218 of the flange 216 may be aligned with the groove 224 in the first wall 185 to facilitate proper positioning and alignment of the piston rod 160 within the cylinder 152. The groove 220 defined between the flange 216 and the piston rod 160 receives the exterior protrusion 222 of the first wall 185, which further assists in maintaining alignment during subsequent assembly steps and during operation of the hydraulic actuator 136. The second end 204 of the piston rod 160 is positioned in the internal volume 153 of the cylinder 152. The second end 204 extends into the internal volume 153 to be accessible from the opening 232 at the second end of the first peripheral wall 188. The piston rod 160 is oriented such that the flange 216 at the first end 202 remains outside of the internal volume 153 while the second end 204 protrudes into the internal volume 153. This positioning allows the second end 204 to be readily accessible for subsequent coupling with the piston head 158. The first seal 210 and the second seal 212 engage the outer surface of the piston rod 160 to provide a fluid-tight seal at the opening 200 in the first wall 185. The piston rod 160 may be axially adjusted to facilitate proper alignment and to facilitate the subsequent assembly steps.

At block 304, the piston 156 receives the piston head 158. More specifically, the piston head 158 is inserted into is inserted into the cylinder 152 (e.g. into the internal volume 153 through the opening 232 at a second end of the first peripheral wall 188). The piston head 158 is inserted with the first seal 264, the second seal 270 and the third seal 272 positioned in the first groove 266, the second groove 274 and the third groove 276, respectively. The opening 254 of the piston head 158 is oriented toward the second end 204 of the piston rod 160 to facilitate coupling. The piston head 158 is advanced into the internal volume 153 until the opening 254 is aligned with the second end 204 of the piston rod 160. The first seal 264 positioned in the first groove 266 is configured to create a fluid-tight seal between the piston head 158 and the piston rod 160 once coupled. The second seal 270 and the third seal 272 positioned in the second groove 274 and the third groove 276, respectively, engage the inner surface of the first peripheral wall 188 to provide a fluid-tight seal between the piston head 158 and the cylinder 152. The seals prevent hydraulic fluid from leaking between the first chamber 172 and the second chamber 180 during operation of the hydraulic actuator 136. The piston head 158 may be axially adjusted within the internal volume 153 to facilitate proper alignment with the second end 204 of the piston rod 160 for subsequent coupling.

At block 306, the piston head 158 is coupled to the piston rod 160. The second end 204 of the piston rod 160 is received in the opening 254 of the piston head 158. The seat 258 of the piston rod 160 engages the seat 260 of the piston head 158. The retainer 262 is coupled onto the piston rod 160 to retain the piston head 158 against the seat 258. In some examples, the retainer 262 is threaded onto the piston rod 160. In some examples, the retainer 262 is press-fitted onto the piston rod 160. The engagement between the seat 258 and the seat 260 provides a secure mechanical interface that transfers axial loads between the piston rod 160 and the piston head 158 during operation. The first seal 264 positioned in the first groove 266 creates a fluid-tight seal between the piston head 158 and the piston rod 160 to prevent hydraulic fluid from leaking at this interface. The retainer 262 is tightened or secured to a predetermined torque or engagement depth to promote reliable retention of the piston head 158 throughout the operational life of the hydraulic actuator 136. Once coupled, the piston rod 160 and the piston head 158 form the piston 156, which moves as a unitary assembly within the cylinder 152.

At block 308, the cap 234 is inserted into the cylinder 152. More specifically, the cap 234 is inserted into the opening 232 at the second end of the first peripheral wall 188. In some examples, the return mechanism 176 is positioned in the second chamber 180 between the piston head 158 and the cap 234 prior to inserting the cap 234. The cap 234 is seated against the seat 236. The return mechanism 176 may be a spring or other biasing element that urges the piston 156 toward a retracted position when hydraulic pressure is released from the first chamber 172. The cap 234 is oriented such that the groove 244 faces the first peripheral wall 188 to receive the seal 242. The cap 234 is advanced into the opening 232 until it contacts the seat 236, which provides a defined axial position for the cap 234 within the cylinder 152. The cap 234 defines the second wall 186 of the cylinder 152 and encloses the second chamber 180.

At block 310, the cap 234 is coupled to the cylinder 152. In particular, the cap 234 is coupled to the first peripheral wall 188 with the retainer 238 to enclose and seal the internal volume 153. The retainer 238 is positioned in the groove 240 defined in the first peripheral wall 188. The seal 242 is positioned in the groove 244 of the cap 234 to seal between the cap 234 and the first peripheral wall 188. The retainer 238 may be configured as a circlip, snap ring, or other suitable retention device that engages the groove 240 to axially retain the cap 234 against the seat 236. The retainer 238 prevents the cap 234 from being displaced by internal pressure within the second chamber 180 during operation of the hydraulic actuator 136. The seal 242 creates a fluid-tight barrier between the cap 234 and the first peripheral wall 188, which allows the second chamber 180 to be configured as a flooded chamber capable of storing hydraulic fluid. Upon completion of block 310, the hydraulic actuator 136 is fully assembled with the piston 156 moveably disposed within the sealed internal volume 153 of the cylinder 152, ready for installation in the hydraulic tool 100.

The above discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the above description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

1. A hydraulic actuator for a hydraulic tool, the hydraulic actuator comprising:
a cylinder having a first peripheral wall extending between a first wall and a second wall to define an interior space, the first wall including an opening; and
a ram moveably disposed within the cylinder, the ram including:
a rod that extends through the opening in the first wall from a first end to a second end,
a piston head at the first end of the rod and disposed within the interior space to define a first chamber between the first wall and the piston head and to define a second chamber between the piston head and the second wall, and
a flange at the second end of the rod and positioned outside of the interior space, the flange engaging the first wall to limit movement of the ram in a first direction caused by fluid being supplied to the first chamber.

2. The hydraulic actuator of claim 1, wherein the flange is formed as a unitary component with the rod and the piston head is a separate component that is coupled to the rod.

3. The hydraulic actuator of claim 1, wherein the flange includes an axial protrusion that is received in a channel formed in the first wall.

4. The hydraulic actuator of claim 3, wherein the axial protrusion is a circumferential wall.

5. The hydraulic actuator of claim 3, wherein a bumper is coupled to the axial protrusion to be between the axial protrusion and the first wall.

6. The hydraulic actuator of claim 1, wherein the cylinder includes a second peripheral wall extending from the first wall and away from the second wall so that the first wall is an interior wall of the cylinder.

7. The hydraulic actuator of claim 1, wherein the second wall is a cap that is coupled to the first peripheral wall.

8. The hydraulic actuator of claim 7, wherein the cap is coupled to the first peripheral wall by a retainer.

9. The hydraulic actuator of claim 7, wherein a seal is formed between the cap and the first peripheral wall so that the second chamber is a flooded chamber.

10. The hydraulic actuator of claim 9, wherein an O-ring or a gasket is positioned between the cap and the first peripheral wall to form the seal.

11. The hydraulic actuator of claim 9, wherein an inlet is provided at the first chamber and an outlet is provided at the second chamber so that fluid is pumped from the second chamber to the first chamber to cause the ram to move in the first direction.

12. A hydraulic actuator for a hydraulic tool, the hydraulic actuator comprising:
a cylinder that includes a peripheral wall and a first wall integrally formed with the peripheral wall, the first wall defining an opening; and
a piston moveably received within the cylinder, the piston including a first piston piece that extends through the opening from a first end and a second end and a second piston piece that is coupled to the first piston piece at the second end,
wherein the first wall and the second piston piece define a first chamber, and
wherein the first end of the first piston piece contacts the first wall to limit movement of the piston in a first direction caused by fluid being supplied to the first chamber.

13. The hydraulic actuator of claim 12, wherein the cylinder includes a removable second wall, and wherein the peripheral wall extends between the first wall and the second wall.

14. The hydraulic actuator of claim 13, wherein the second piston piece and the second wall define a second chamber.

15. The hydraulic actuator of claim 14, wherein the second piston piece contacts the first wall to limit movement of the piston in a second direction caused by fluid being supplied to the second chamber.

16. The hydraulic actuator of claim 15, wherein the second piston piece contacts an interior protrusion of the first wall.

17. The hydraulic actuator of claim 12, wherein the first end of the first piston piece includes a flange that is located outside the first chamber and engages the first wall to limit movement of the piston in the first direction.

18. The hydraulic actuator of claim 17, wherein the flange includes an axial protrusion that is received in a channel formed in the first wall.

19. A hydraulic tool, comprising:
a housing;
a working head coupled to the housing;
a hydraulic actuator comprising:
a cylinder having a first peripheral wall extending between a first wall and a second wall to define an internal volume, the first wall including an opening, the second wall being defined by a cap coupled to the first peripheral wall;
a ram moveably disposed within the cylinder, the ram including:
a rod extending through the opening in the first wall from a first end positioned outside of the internal volume to a second end positioned inside the internal volume,
a piston head coupled to the second end of the rod and disposed within the internal volume to define a first chamber between the first wall and the piston head and to define a second chamber between the piston head and the cap,
a flange at the first end of the rod and positioned outside of the internal volume, the flange engaging the first wall to limit movement of the ram in a first direction caused by fluid being supplied to the first chamber; and
a pump positioned in the housing to supply fluid to the first chamber.

20. (canceled)
